(19) United States
(12) Patent Application Publication
(10) Pub. No.: US 2014/0234819 A1
(43) Pub. Date: Aug. 21, 2014

(54) ACTION PRESENTATION DEVICE, ACTION PRESENTATION METHOD, AND RECORDING MEDIUM

(71) Applicants: Rie Tanaka, Tokyo (JP); Shinichi Doi, Tokyo (JP); Taku Konishi, Tokyo (JP); Satoko Itaya, Tokyo (JP); Naoki Yoshinaga, Tokyo (JP)

(72) Inventors: Rie Tanaka, Tokyo (JP); Shinichi Doi, Tokyo (JP); Taku Konishi, Tokyo (JP); Satoko Itaya, Tokyo (JP); Naoki Yoshinaga, Tokyo (JP)

(73) Assignee: NEC CORPORATION, Minato-ku, Tokyo (JP)

(21) Appl. No.: 14/117,521

(22) PCT Filed: May 9, 2012
(86) PCT No.: PCT/JP2012/061905

§ 371 Date: Nov. 13, 2013

(30) Foreign Application Priority Data
May 13, 2011 (JP) 2011-108498

(51) Int. Cl. G09B 19/00

(52) U.S. Cl. CPC G09B 19/00
USPC 434/238

(57) ABSTRACT

An updater (16) of a behavior presentation device (1), on the basis of performed-behavior information acquired by a behavior information acquirer (15) and indicating a behavior performed by a target group comprising a plurality of users or a single target user, updates a behavior list stored by a behavior list storer (11) and indicating a possible behavior of the target group or the target user, and user information stored by a user information storer (12) and indicating a behavioral habit of the target group or the target user. On the basis of the user information, a presentation information generator (13) extracts, from the behavior list, a behavior that conforms with a predetermined evaluation criterion. The presentation information generator (13) generates presentation information for displaying the behavior extracted, and sends the presentation information to a display (14). The display (14) displays the presentation information and presents the behavior to the user.

### TECHNICAL FIELD

The present invention relates to a behavior presentation device, behavior presentation method, and recording medium with which a behavior is presented to a user.

### BACKGROUND ART

Interest in environmental problems increases year by year, and the number of people who wish to reduce environmental burdens that have a negative influence on the global environment within daily life is increasing. Furthermore, since it is possible for the effect of an improvement in the global environment to be expected if individuals and corporations reduce behaviors that are associated with environmental burdens, there exists technology with which information regarding environmental burdens such as the amount of electricity, gasoline, gas, and the like used or the amount of CO₂ emitted by a user is presented to the user to motivate the behavior of the user.

In Patent Literature 1, a system is proposed in which a user inputs an image of a behavior to be performed by the user him or herself, the user writes the result of performing the behavior in a diary, and the user receives feedback in the form of comments from other users who have seen the diary.

In Patent Literature 2, technology is proposed in which biometric data such as the brain waves and body temperature of a user and environment data such as air temperature and air pressure are analyzed in combination with a list of past behaviors, a comparison is made with the future schedule of the user, and advice is given as to what kind of health condition will be attained if the user performs behavior according to that schedule.

In Patent Literature 3, an electronic computer is presented which computes a social network configuration model that takes into account the influence that communication over the social network has on the consumption behavior of a consumer.

In Patent Literature 4, a behavior prediction system is presented in which the present condition of a user is analyzed, and behavior candidates which are candidates for the next behavior of the user are generated on the basis of behavior history information. This behavior prediction system learns from user selection results or behavior results, and controls the generation of behavior candidates on the basis of the learning results and the present condition of the user.

In Patent Literature 5, a behavior promotion and suppression system is presented in which the behavior of a user is promoted by presenting information as to his or her (the user) position among all users, and information as to the present condition of other users (rivals) in the vicinity of the position of the user.

### CITATION LIST

### Patent Literature

Patent Literature 1: Unexamined Japanese Patent Application Kokai Publication No. 2008-217621
Patent Literature 2: Unexamined Japanese Patent Application Kokai Publication No. H10-305016
Patent Literature 3: Unexamined Japanese Patent Application Kokai Publication No. 2009-116844
Patent Literature 4: Unexamined Japanese Patent Application Kokai Publication No. 2010-146276
Patent Literature 5: Unexamined Japanese Patent Application Kokai Publication No. 2010-204883

### SUMMARY OF INVENTION

### Technical Problem

However, if a behavior that reduces an environmental burden is prompted to a user, the likelihood of the user performing the behavior is low if a behavior that is difficult for the user to perform or a behavior that the user has a low intention of performing is prompted.

Technology that prompts a user with a behavior having a high likelihood of being performed from among behaviors that reduce an environmental burden is not disclosed in Patent Literatures 1 to 5.

The present invention takes into account the aforementioned circumstances, and an objective of the invention is to provide a behavior presentation device, a behavior presentation method, and recording medium with which the likelihood of a user performing a behavior that reduces an environmental burden is increased.

### Solution to Problem

A behavior presentation device according to a first aspect of the present invention comprises:

behavior list storage means that stores a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;

user information storage means that stores user information indicating a behavioral habit of the target group or the target user;

behavior information acquisition means that acquires performed-behavior information indicating a behavior performed by the target group or the target user;

update means that updates the behavior list and the user information on the basis of the performed-behavior information;

extraction means that, on the basis of the user information, extracts behavior information for which at least either the cost or the evaluation value conforms with a predetermined evaluation criterion, from among the behavior information included in the behavior list;

generation means that generates presentation information for displaying the behavior information extracted; and

presentation means that presents the presentation information to the target group or the target user.

A behavior presentation method according to a second aspect of the present invention is a behavior presentation method that is performed by a behavior presentation device that presents a behavior to a target user, the behavior presentation method comprising:

a behavior list storage step for storing a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;

a user information storage step for storing user information indicating a behavioral habit of the target group or the target user;

a behavior information acquisition step for acquiring performed-behavior information indicating a behavior performed by the target group or the target user;

an update step for updating the behavior list and the user information on the basis of the performed-behavior information;

an extraction step for, on the basis of the user information, extracting behavior information for which at least either the cost or the evaluation value conforms with a predetermined evaluation criterion, from among the behavior information included in the behavior list;

a generation step for generating presentation information for displaying the behavior information extracted; and

a presentation step for presenting the presentation information to the target group or the target user.

A computer-readable recording medium according to a third aspect of the present invention has recorded thereon a program causing a computer to function as:

behavior list storage means that stores a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;

user information storage means that stores user information indicating a behavioral habit of the target group or the target user;

behavior information acquisition means that acquires performed-behavior information indicating a behavior performed by the target group or the target user;

update means that updates the behavior list and the user information on the basis of the performed-behavior information;

extraction means that, on the basis of the user information, extracts behavior information for which at least either the cost or the evaluation value conforms with a predetermined evaluation criterion, from among the behavior information included in the behavior list;

generation means that generates presentation information for displaying the behavior information extracted; and

presentation means that presents the presentation information to the target group or the target user.

### Advantageous Effects of Invention

According to the present invention, it is possible for the likelihood of a user performing a behavior that reduces an environmental burden to be increased.

### BRIEF DESCRIPTION OF DRAWINGS

FIG. 1 is a block diagram depicting an exemplary functional configuration of a behavior presentation device according to Embodiment 1 of the present invention;

FIG. 2A is a drawing depicting an example of a behavior list according to Embodiment 1;

FIG. 2B is a drawing depicting an example of user information according to Embodiment 1;

FIG. 3 is a flowchart depicting an example of a behavior presentation operation according to Embodiment 1;

FIG. 4 is a block diagram depicting an exemplary functional configuration of a behavior presentation device according to Embodiment 2 of the present invention;

FIG. 5A is a drawing depicting an example of a behavior list according to Embodiment 2;

FIG. 5B is a drawing depicting an example of a behavior list according to Embodiment 2;

FIG. 6A is a drawing depicting an example of user information according to Embodiment 2;

FIG. 6B is a drawing depicting an example of user information according to Embodiment 2;

FIG. 7 is a flowchart depicting an example of a behavior presentation operation according to Embodiment 2; and

FIG. 8 is a block diagram depicting an exemplary hardware configuration of a behavior presentation device according to the embodiments.

### DESCRIPTION OF EMBODIMENTS

An environmental burden in the present embodiments is an act that has a negative influence on the global environment such as the use of electricity, gasoline, gas, and the like and the emission of CO₂, or refers to a negative influence caused thereby. Furthermore, an evaluation value indicating an effect produced if a behavior is performed is, for example, a value indicating the influence on the environment per unit time. An evaluation value indicating a benefit produced if a behavior is performed is, for example, the amount of money saved if the behavior is performed.

Modes for carrying out the present invention will hereafter be described in detail with reference to the drawings. It should be noted that, in the figures,

### Embodiment 1

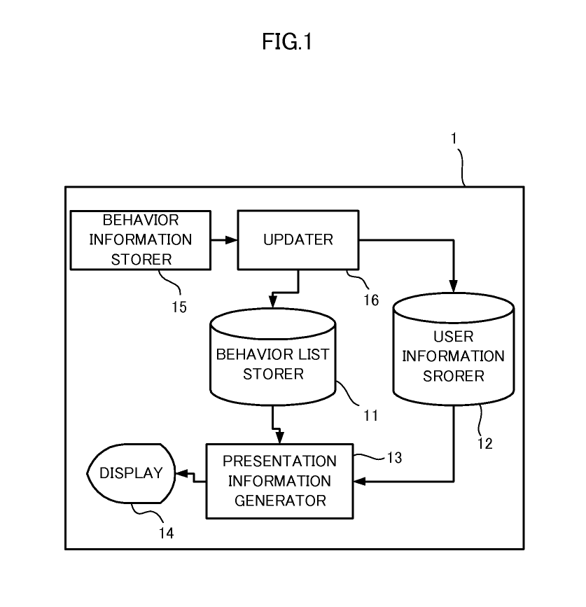

FIG. 1 is a block diagram depicting an exemplary functional configuration of a behavior presentation device according to Embodiment 1. A behavior presentation device 1 comprises a behavior list storer 11, a user information storer 12, a presentation information generator 13, a display 14, a behavior information acquirer 15, and an updater 16. In Embodiment 1, a target for the presentation of behavior information is a single user (hereafter referred to as a target user).

The behavior list storer 11 stores a behavior list in which information of a possible behavior of the target user, and a cost indicating the difficulty of the behavior indicated by the behavior information and an evaluation value indicating an effect or a benefit produced if the behavior is performed are associated. It should be noted that it is permissible for the behavior list to be input to the behavior presentation device 1 by the target user, or to be acquired from an external device. The details of the behavior list are described hereafter.

The user information storer 12 stores user information indicating a behavioral habit of the target user. It should be noted that it is permissible for the user information to be input to the behavior presentation device 1 by the target user, or to be acquired from an external device. The details of the user information are described hereafter.

The presentation information generator 13, on the basis of the user information stored by the user information storer 12, extracts behavior information that conforms with a predetermined evaluation criterion based on at least either the cost or the evaluation value, from the behavior list stored by the behavior list storer 11. The behavior information extracted here is not restricted to one item of information. The predetermined evaluation criterion is, for example, to minimize the cost and to maximize the evaluation value that indicates an effect or a benefit. Furthermore, it is permissible for the predetermined evaluation criterion to be stored in advance by the presentation information generator 13, or to be acquired from an external device. A specific extraction method is described hereafter.

Furthermore, the presentation information generator 13 generates presentation information for displaying the behavior information extracted, and provides the presentation information to the display 14. If the presentation information generator 13 has extracted a plurality of behavior information items, it is permissible for presentation information to be generated after changing the order of the plurality of behavior information items to a predetermined order. For example, it is permissible for the order of the plurality of behavior information items to be changed to an order such as the ascending order of the cost or the descending order of the evaluation value. Alternatively, it is permissible for the presentation information generator 13 to generate presentation information in a format such that target-user behavior information of a predetermined period is scheduled and displayed on the display 14. Furthermore, it is permissible for the presentation information generator 13 to cause the generated presentation information to be transmitted and displayed on another terminal that is viewable by the target user such as a mobile terminal in the possession of the target user.

The display 14 displays presentation information received from the presentation information generator 13. It should be noted that it is permissible for the presentation information to be audio, and for the display 14 to output the presentation information as audio.

The behavior information acquirer 15 acquires performed-behavior information indicating a behavior performed by the target user. For example, performed-behavior information indicating that an electrical appliance has been used is acquired by detecting the power consumption of the electrical appliance by using a power consumption meter provided in the electrical appliance. Performed-behavior information indicating that shopping has been carried out is acquired by detecting the use of a credit card or electric money and the like. It is permissible for GPS (Global Positioning System) information to be acquired from a mobile terminal in the possession of the target user for example, as performed-behavior information indicating that a movement has been made. In this case, it is permissible for the movement means (car, train, walking, and the like) to be identified on the basis of movement speed or acceleration, and map information and the like. It should be noted that it is permissible for the performed-behavior information to be input to the behavior presentation device 1 by the target user.

The updater 16, on the basis of performed-behavior information acquired by the behavior information acquirer 15, determines whether or not the target user has performed a behavior indicated by the presentation information displayed on the display 14. On the basis of the determination result, the updater 16 then updates the behavior list stored by the behavior list storer 11 and the user information stored by the user information storer 12. A specific update method is described hereafter.

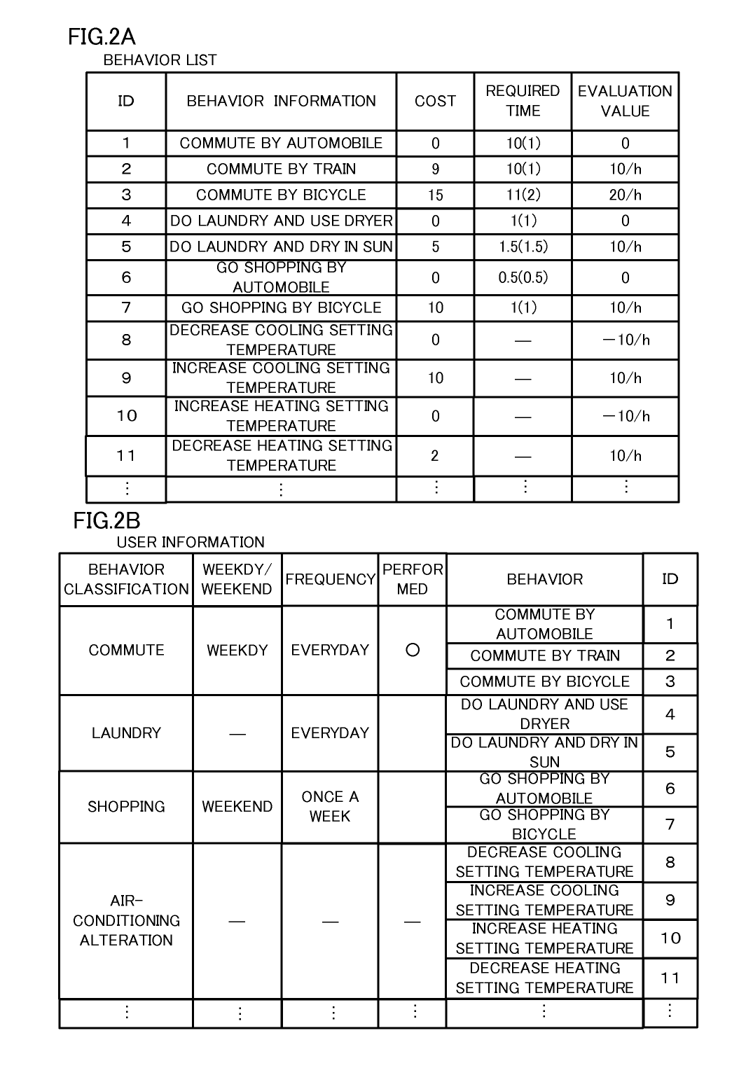

FIG. 2A is a drawing depicting an example of a behavior list according to Embodiment 1, and FIG. 2B is a drawing depicting an example of user information according to Embodiment 1. FIG. 2A is an example of a behavior list stored by the behavior list storer 11. In the example of FIG. 2A, the behavior list comprises the items of an “ID” identifying behavior information, “behavior information” indicating the content of a behavior, “cost” indicating the difficulty of a behavior, a “required time” indicating the time required for a behavior, and an “evaluation value” indicating the degree of positive influence on the environment per hour in the case where a behavior is performed.

It should be noted that it is permissible for the “required time” to be measured when the target user actually performs the behavior, or to be input by the target user. It should be noted that the numeral inside the parentheses to the side of the “required time” indicates a performed time that indicates the time in which the behavior is actually performed. Furthermore, the value of “cost” is updated by the updater 16. It is permissible for the initial value of “cost” to be the same value for all behaviors, to be the same as the value for the “evaluation value” that indicates the degree of positive influence on the environment, or to be input by the target user.

The “evaluation value” is not restricted to a value indicating the degree of positive influence on the environment, and it is permissible for the “evaluation value” to be a value indicating the degree of negative influence on the environment. It is permissible for the “evaluation value” to be predetermined as a value evaluated from the viewpoint of the use of electricity, gasoline, gas, and the like or the emission of CO₂, or to be the actual amount of electricity, gasoline, gas, and the like used or the actual amount of CO₂ emitted. Furthermore, it is permissible for the “evaluation value” to simply be “1” if there is a positive influence on the environment or to be “0” if there is not. It is permissible to determine whether or not there is a positive influence from, for example, a value such as the amount of electricity, gasoline, gas, and the like used or the amount of CO₂ emitted, in accordance with predetermined criterion. Alternatively, it is permissible for the “evaluation value” to be the amount of money saved if the behavior is performed, or to simply be “1” if a predetermined amount of money is saved, and to be “0” if the predetermined amount of money is not saved.

For example, the behavior of ID 1 of commuting by automobile has a difficulty of 0, takes 10 hours from going to work until returning home (performed time is one hour), and does not have a positive influence on the environment. The behavior of ID 2 of commuting by train has a difficulty-indicating value of 9, takes 10 hours from going to work until returning home (performed time is one hour), and has a value indicating the degree of positive influence on the environment per hour of 10. If the target user performs the behavior of commuting by train, the presentation information generator 13 determines that there is a positive influence on the environment of (performed time)×(evaluation value)=1×10=10. It should be noted that, because the behaviors of IDs 8 to 11 are behaviors that alter setting temperature for air conditioning (remote-control operation or the like), there is no required time, and it is possible for the performed time to be arbitrarily determined (denoted by “-” in the drawing).

FIG. 2B is an example of user information stored by the user information storer 12. In the example of FIG. 2B, user information comprises the items of a “behavior classification” representing the type of behavior, “weekday/weekend” indicating whether a behavior is performed on a weekday or is performed on a weekend, a “frequency” indicating the frequency at which a behavior is performed, “performed” indicating whether or not a behavior has been performed, “behavior” indicating the content of a behavior, and an “ID” identifying behavior information.

The “ID” and “behavior” in the user information indicate the same as that in the behavior list. With regard to the “weekday/weekend” item, “weekday” indicates that a behavior is performed only on weekdays, “weekend” indicates that a behavior is performed only on weekends, and “-” indicates that a behavior is performed at any time. Furthermore, with regard to the “frequency” item, “-” indicates that the frequency is not set and that it is permissible for a behavior to be performed any number of times. A behavior for which “∘” is input for the “performed” item is indicated to have been performed. It should be noted that the “frequency” item is associated with the “performed” item. If the period indicated by the “frequency” elapses after “∘” has been input in the “performed” item, “∘” in the “performed” item is erased. If the “frequency” item is “-”, because it is permissible for a behavior to be performed any number of times, “-” is input in the “performed” item.

For example, the “commuting” type of behavior is a behavior that is performed every weekday, and has already been performed. There are three behaviors as the “commuting” type of behavior, and these are “commute by automobile” for which the “ID” is 1, “commute by train” for which the “ID” is 2, and “commute by bicycle” for which the “ID” is 3. Since the “commuting” type of behavior has a “frequency” of every day, “∘” is erased twenty-four hours after “∘” has been input in the “performed” item, and the “commuting” type of behavior assumes a not-performed state.

On the basis of the user information, the presentation information generator 13 extracts, from the behavior list, behavior information that conforms with a predetermined evaluation criterion based on at least either the cost or the evaluation value. A specific extraction method will hereafter be described using the examples of FIG. 2A and FIG. 2B.

For example, if a predetermined day on which behavior information is presented is a weekday, the presentation information generator 13 refers to the “weekday/weekend” item in the user information, and extracts behaviors having the weekday behavior classification. Furthermore, the presentation information generator 13 refers to the “performed” item in the user information, and extracts behaviors that have not yet been performed. Next, the presentation information generator 13 refers to the “cost”, “predetermined time”, and “evaluation value” items in the behavior list for the extracted behaviors, and extracts a behavior that is performable in one day and is a behavior having the lowest cost and the highest positive influence on the environment.

Here, the cost being the lowest and the positive influence on the environment being the highest refers to when subtracting the total “cost” value of a behavior from the total “evaluation value” produces the highest result. The predetermined evaluation criterion is not restricted to this example, and it is permissible for a weighting to be applied to either the “cost” or the “evaluation value”, for the evaluation criterion to be that the evaluation value is the highest with no relation to the cost, or for the evaluation criterion to be that the evaluation value is a positive value and the cost is the lowest.

It should be noted that the time in which a behavior is performed in one day is predetermined, and is twelve hours for example. Furthermore, if the predetermined evaluation criterion is based only upon the evaluation value, it is permissible for the behavior list to comprise the “behavior”, “required time”, and “evaluation value”. If a value indicating the degree of negative influence on the environment is used for the “evaluation value”, the cost being the lowest and the positive influence on the environment being the highest refers to when adding the total “evaluation value” of a behavior and the total “cost” value produces the lowest result.

The updater 16 updates the user information and the behavior list on the basis of the behavior information acquired by the behavior information acquirer 15. A specific update method will hereafter be described using the examples of FIG. 2A and FIG. 2B.

If, for example, the updater 16 has determined that the behavior information acquired by the behavior information acquirer 15 indicates that the target user has commuted by train, “∘” is input in the “performed” item for which the “behavior classification” is “commute” in the user information. Furthermore, statistics of past performed-behavior information of the user are acquired, and if there has been a change in the behavioral habits of the user such as the day of the week or the frequency at which a behavior is performed, the “weekday/weekend” item or the “frequency” item is altered. Furthermore, if the updater 16 determines that the target user has performed a presented behavior and commuted by train, the updater 16 subtracts 1 from the “cost” value for “commute by train”, which is the behavior information having the “ID” of “2” in the behavior list. It should be noted that it is permissible for the updater 16 to add 1 to the “cost” value for behavior information that has been determined to have not been performed, from among the presented behavior information. Furthermore, it is permissible for the value that is added or subtracted to not be restricted to 1 and to be an arbitrary value.

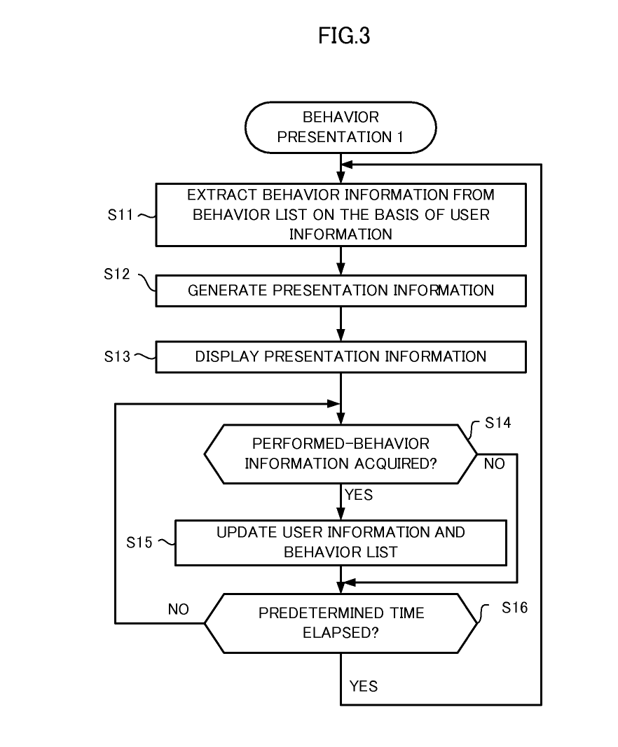

FIG. 3 is a flowchart depicting an example of an operation for presenting behavior information in the behavior presentation device 1 of Embodiment 1. The behavior presentation device 1, for example, starts the operation as result of user designation information that designates a user being input. First, on the basis of the user information that is stored by the user information storer 12 and corresponds to the input user designation information, the presentation information generator 13 of the behavior presentation device 1 extracts behavior information that conforms with a predetermined evaluation criterion based on at least either the cost or the evaluation value, from the behavior list stored in the behavior list storer 11 (step S11).

The presentation information generator 13 generates presentation information for displaying the behavior information extracted (step S12), and causes the presentation information to be displayed on the display 14 (step S13).

The updater 16 determines whether or not the behavior information acquirer 15 has acquired performed-behavior information (step S14). If performed-behavior information has not been acquired (step S14: NO), whether or not a predetermined time has elapsed is determined (step S16). If performed-behavior information has been acquired (step S14: YES), the updater 16 updates the user information and behavior list on the basis of the performed-behavior information (step S15), and determines whether or not a predetermined time has elapsed (step S16).

If the predetermined time has not elapsed (step S16: NO), processing returns to that of step S14, and the processing of step S14 to step S16 is repeated. If the predetermined time has elapsed (step S16: YES), processing returns to that of step S11, and the processing of step S11 to step S16 is repeated.

As described above, according to the behavior presentation device 1 of Embodiment 1, because it is possible for behavior information that reduces an environmental burden to be presented and prompted to a user in accordance with the behavioral habits of the user, it is possible to increase the likelihood of the user performing the behavior that reduces the environmental burden.

### Embodiment 2

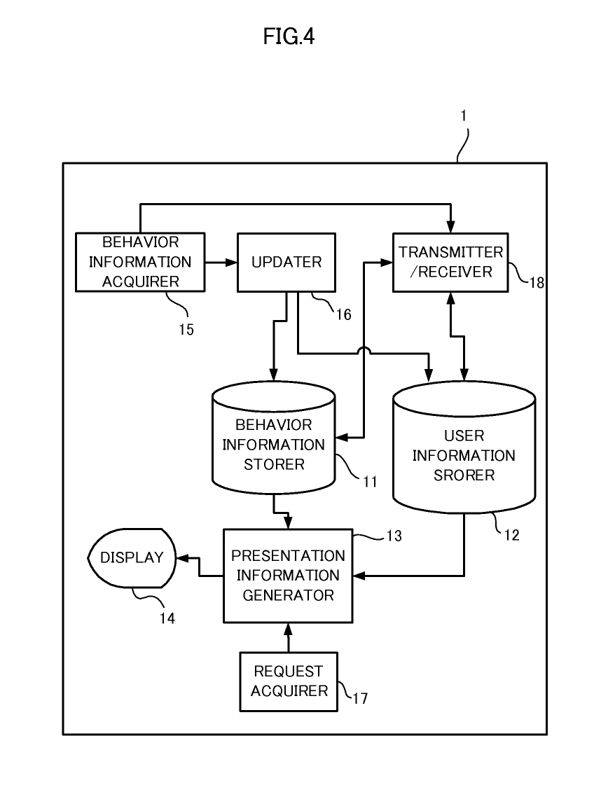

FIG. 4 is a block diagram depicting an exemplary functional configuration of a behavior presentation device according to Embodiment 2 of the present invention. The behavior presentation device 1 of Embodiment 2 comprises a request acquirer 17 and a transmitter/receiver 18 in addition to the configuration of the behavior presentation device 1 of Embodiment 1. Furthermore, in contrast to the target for the presentation of behavior information being a single user in Embodiment 1, the target for the presentation of behavior information in Embodiment 2 is a group of a plurality of users (hereafter referred to as a target group). A behavior presentation device 1 is provided for each of the users included in the target group. The following description will focus on a single user in the target group. The user focused upon is hereafter referred to as the user of interest, and a user other than the user of interest in the target group is referred to as another user.

The request acquirer 17 of the behavior presentation device 1 of the user of interest acquires a request regarding a target-group behavior associated with an environmental burden. The request regarding a target-group behavior associated with an environmental burden is, for example, a request such as “in the case where the behaviors that are good for the environment from among the behaviors performed by the target group in one month are converted to numerical values, set the total value to 300”. It should be noted that it is permissible for the request regarding a target-group behavior associated with an environmental burden to be, for example, input by a user included in the target group, or to be input by an entity other than a user such as a municipality to which the target group belongs. A period indicated by a request is hereafter referred to as a request period.

The behavior list storer 11 stores behavior lists of the users in the target group. It should be noted that it is permissible for the behavior list of the user of interest to be input to the behavior presentation device 1 by the user of interest, or to be acquired from an external device. The details of the behavior list are described hereafter.

The user information storer 12 stores user information of the users in the target group. It should be noted that it is permissible for the user information of the user of interest to be input to the behavior presentation device 1 by the user of interest, or to be acquired from an external device. The details of the user information are described hereafter.

On the basis of the user information stored by the user information storer 12, the presentation information generator 13 extracts, from a behavior list stored by the behavior list storer 11, behavior information of a user in the user group that conforms with a predetermined evaluation criterion based on at least either the cost or the evaluation value and that satisfies a request acquired by the request acquirer 17. A specific extraction method is described hereafter.

The presentation information generator 13 determines whether or not a behavior of the user of interest is included within the extracted behaviors. If behavior information of the user of interest is included, the presentation information generator 13 generates presentation information for displaying the behavior information of the user of interest, and provides the presentation information to the display 14. The display 14 displays the presentation information received from the presentation information generator 13.

The behavior information acquirer 15 acquires performed-behavior information indicating a behavior performed by the user of interest.

On the basis of the performed-behavior information acquired by the behavior information acquirer 15, the updater 16 determines whether or not the user of interest has performed a behavior indicated by the presentation information displayed on the display 14, and updates the behavior list of the user of interest stored by the behavior list storer 11 and the user information of the user of interest stored by the user information storer 12.

If the behavior list and user information of the user of interest are updated by the updater 16, the transmitter/receiver 18 transmits the updated behavior list and user information of the user of interest to the behavior presentation device 1 of another user. In addition, the transmitter/receiver 18 receives the updated user information and behavior list of the other user.

Furthermore, if the updated user information and behavior list of the other user is received by the transmitter/receiver 18, the updater 16 overwrites and updates each of the behavior list of the other user stored by the behavior list storer 11 and the user information of the other user stored by the user information storer 12.

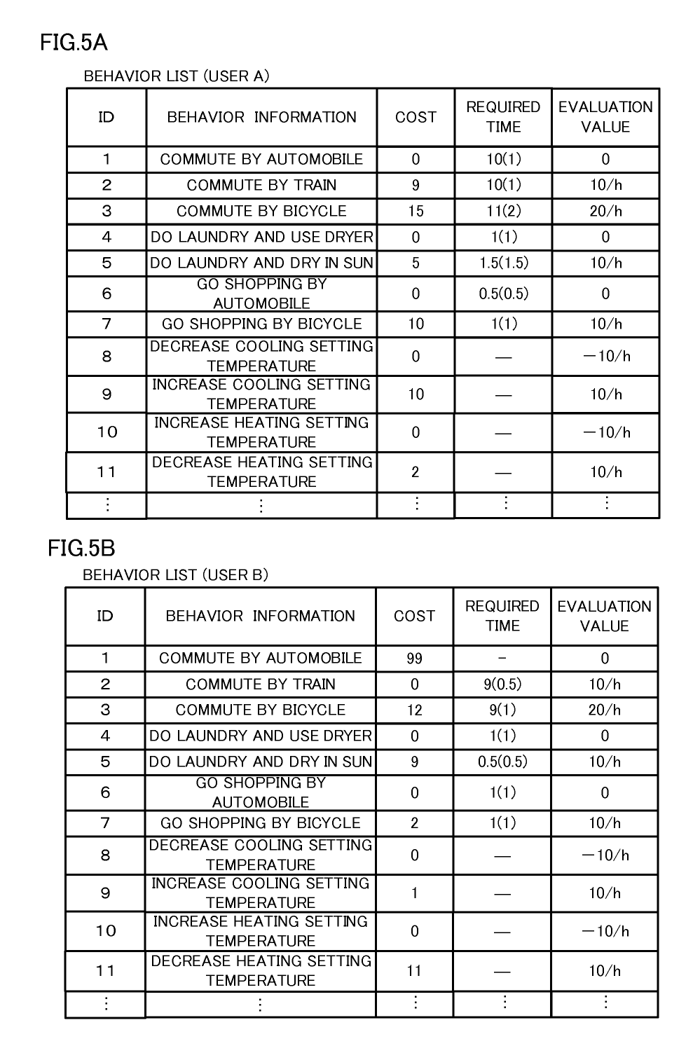

FIG. 5A and FIG. 5B are drawings depicting examples of behavior lists according to Embodiment 2. The example of FIG. 5A depicts the behavior list of user A who is representative of the users in the target group, and the example of FIG. 5B depicts the behavior list of user B who is representative of the users in the target group. As in the behavior list depicted in FIG. 2A, the behavior lists depicted in FIG. 5A and FIG. 5B comprise the items of an “ID” identifying behavior information, “behavior information” indicating the content of a behavior, “cost” indicating the difficulty of a behavior, “required time” indicating the time required for a behavior, and an “evaluation value” indicating the degree of positive influence on the environment per hour in the case where a behavior is performed. It is permissible for the behavior content indicated by the “behavior information” item to be the same for all users in the target group, or to be different for each user.

For example, for user A, the behavior of ID 1 of commuting by automobile has a difficulty-indicating value of 0, takes 10 hours from going to work until returning home (performed time is one hour), and does not have a positive influence on the environment. On the other hand, for user B, the behavior of ID 1 of commuting by automobile has a difficulty-indicating value of 99, the required time is unknown (denoted by “-” in the drawing), and does not have a positive influence on the environment. Here, performing the behavior is not possible in cases such as when the difficulty-indicating value is 99, and when user B does not have an automobile for example.

For user A, the behavior of ID 2 of commuting by train has a difficulty-indicating value of 9, takes 10 hours from going to work until returning home (performed time is one hour), and has a value indicating the degree of positive influence on the environment per hour of 10. On the other hand, for user B, the behavior of ID 2 of commuting by train has a difficulty-indicating value of 0, takes nine hours from going to work until returning home (performed time is 0.5 hours), and has a value indicating the degree of positive influence on the environment per hour of 10.

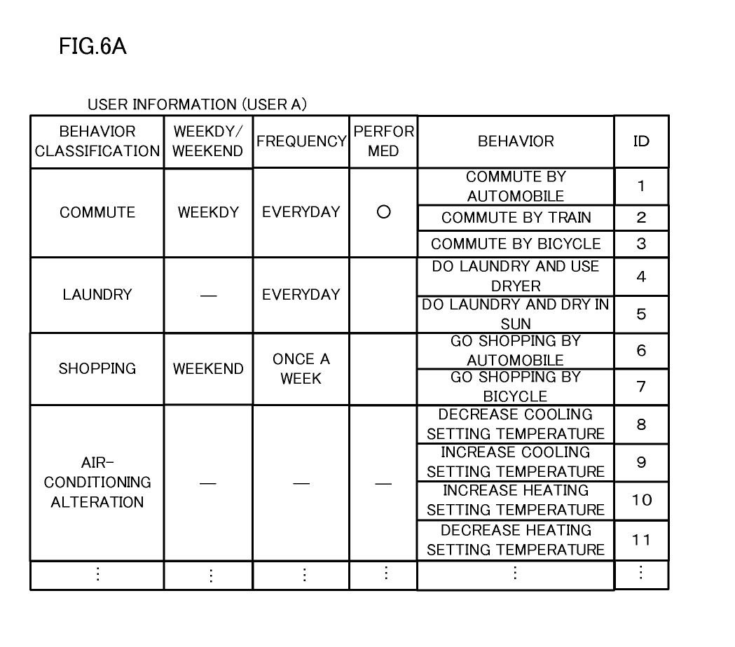

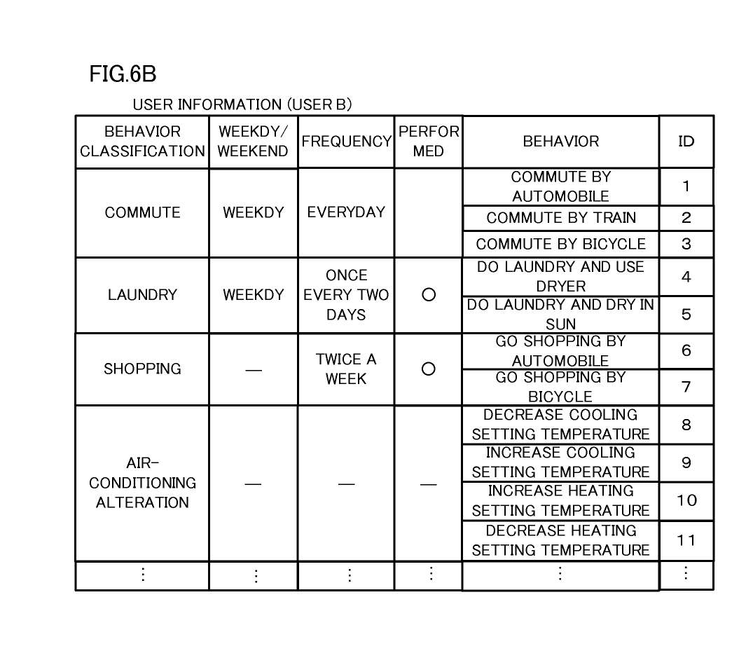

FIG. 6A and FIG. 6B are drawings depicting examples of user information according to Embodiment 2. The examples of FIG. 6A and FIG. 6B, as in FIG. 5A and FIG. 5B, depict the user information of user A and user B who are representative of the users in the target group. The user information depicted in FIG. 6A and FIG. 6B, as in the user information depicted in FIG. 2B, comprises the items of “behavior classification” representing the type of behavior, “weekday/weekend” indicating whether a behavior is performed on a weekday or is performed on a weekend, a “frequency” indicating the frequency at which a behavior is performed, “performed” indicating whether or not a behavior is performed, “behavior” indicating the content of a behavior, and an “ID” identifying behavior information.

For example, in the examples depicted in the drawings, the “laundry” type of behavior is, for user A, a behavior that is performed every day with no relation to weekdays or the weekend and is, for user B, a behavior that is performed once every two weekdays. Furthermore, it is depicted that user A has not yet carried out laundry but user B has already carried out laundry.

On the basis of the user information of a user in the target group, the presentation information generator 13 extracts, from the behavior list of the user in the target group, a behavior that conforms with a predetermined evaluation criterion based on at least either the cost or the evaluation value and that satisfies a request. A specific extraction method will hereafter be described using the examples of FIG. 5A and FIG. 5B and of FIG. 6A and FIG. 6B. Let us assume that, for example, a request regarding a user behavior associated with an environmental burden and acquired by the request acquirer 17 is “in the case where the behaviors that are good for the environment from among the behaviors performed by the target group in one week are converted to numerical values, set the total value to 300”. The presentation information generator 13 refers to the behavior list and user information of the users in the target group, and extracts behavior information for one week of the users in the target group for which the total value of (performed time)×(evaluation value) is 300 and for which the total cost value is the lowest. If a behavior of a user of interest is included in the extracted behavior information, the presentation information generator 13 then generates presentation information for displaying the behavior of the user of interest, and provides the presentation information to the display 14.

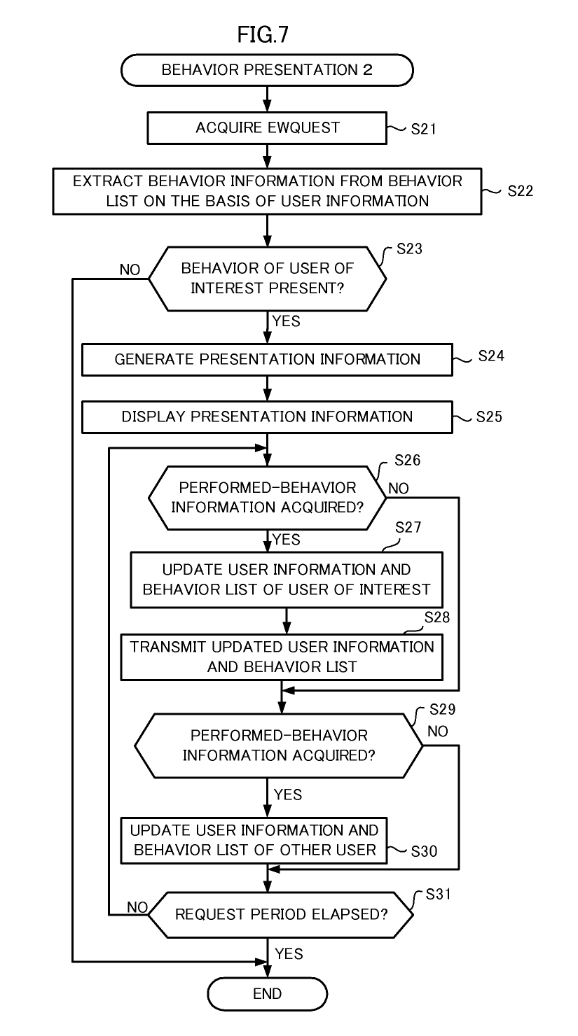

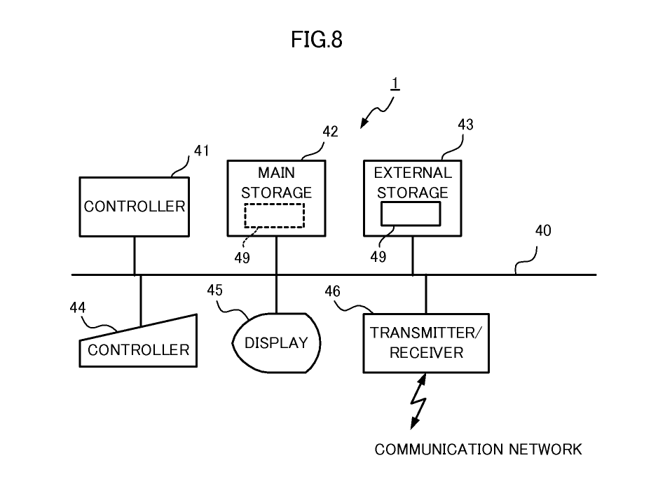

FIG. 7 is a flowchart depicting an example of an operation for presenting behavior information in the behavior presentation device 1 of Embodiment 2. The request acquirer 17 of the behavior presentation device 1 acquires a request regarding a user behavior associated with an environmental burden (step S21). On the basis of the user information of the users in the target group stored by the user information storer 12, the presentation information generator 13 extracts, from the behavior lists of the users in the target group stored by the behavior list storer 11, behavior information that conforms with a predetermined evaluation criterion based on at least either the cost or the evaluation value and that satisfies the request acquired by the request acquirer 17 (step S22).

The presentation information generator 13 determines whether or not a behavior of the user of interest is present in the behaviors indicated by the extracted behavior information (step S23). If a behavior of the user of interest is not present (step S23: NO), processing is finished. On the other hand, if a behavior of the user of interest is present (step S23: YES), the presentation information generator 13 generates presentation information for displaying the behavior of the user of interest (step S24), and causes the presentation information to be displayed on the display 14 (step S25).

The updater 16 determines whether or not the behavior information acquirer 15 has acquired performed-behavior information of the user of interest (step S26). If performed-behavior information of the user of interest has not been acquired (step S26: NO), the updater 16 determines whether or not the updated user information and behavior list of another user have been received by the transmitter/receiver 18 (step S29).

On the other hand, if performed-behavior information of the user of interest has been acquired (step S26: YES), the updater 16 updates the user information and behavior list of the user of interest on the basis of the performed-behavior information of the user of interest (step S27). The transmitter/receiver 18 then transmits the user information and behavior list of the user of interest that have been updated by the updater 16, to the behavior presentation device 1 of a user other than the user of interest (step S28). The updater 16 then determines whether or not updated user information and behavior list of another user have been received by the transmitter/receiver 18 (step S29).

If the updated user information and behavior list of another user have not been received by the transmitter/receiver 18 (step S29: NO), the updater 16 determines whether or not the request period has elapsed (step S31). If the transmitter/receiver 18 has received the updated user information and behavior list of another user (step S29: YES), the updater 16 overwrites and updates the behavior list and user information of the other user with the user information and behavior list of the other user (step S30). The updater 16 then determines whether or not the request period has elapsed (step S31).

If the request period has not elapsed (step S31: NO), processing returns to that of step S26, and the processing of step S26 to step S31 is repeated. If the request period has elapsed (step S31: YES), processing is finished.

In the present embodiments, the presentation information generator 13 generates presentation information and sends the presentation information to the display 14 only if a behavior of a user of interest is included in behavior information extracted by the presentation information generator 13. However, it is also permissible for the presentation information generator 13 to add a predetermined condition with respect to the extraction of a behavior. For example, it is permissible to add a condition such as to extract at least one item of behavior information of all users in the target group. In this case, a behavior of the user of interest will definitely be included in the extracted behavior information. It therefore becomes unnecessary to determine whether or not a behavior of the user of interest is included in the extracted behavior information.

Furthermore, it is permissible to add a condition such as to separate the users in the target group into groups, and extract only the behavior information of users of a group that conforms with a request. For example, with regard to each “behavior classification” of the user information, users for which the “cost” value in the behavior list is lower than a predetermined value are formed into groups, and groups such as a commuting group, laundry group, shopping group, and air-conditioning alteration group are formed. If a request acquired by the request acquirer 17 is a request relating to “commuting”, the presentation information generator 13 extracts only behavior information of users in the commuting group. Separation into groups is not restricted to this mode, and on the basis of the probability of a user performing a behavior (presented behavior) indicated by presented behavior information, it is permissible to create groups such as a group that performs a presented behavior, a group that performs a presented behavior to an extent, a group that, to an extent, does not perform a presented behavior, and a group that does not perform a presented behavior. In this way, by narrowing down the behavior of a request-conforming group in advance, the amount of data to be processed decreases, and the processing speed therefore increases.

In addition, with respect to a request acquired by the request acquirer 17, it is permissible to add a condition such as to extract behavior information by taking into consideration the percentage of users in a target group who performed a presented behavior in the past or a percentage at which the request was fulfilled. In this case, the behavior presentation device 1 further comprises a percentage storer that, on the basis of performed-behavior information acquired by the behavior information acquirer 15, computes the percentage of users who performed a presented behavior or the percentage at which a request was fulfilled, and associates and stores the calculated percentage and the request. The presentation information generator 13 refers to the percentage storer, and determines whether or not a request that is the same as the request acquired by the request acquirer 17 has been acquired in the past. In the case where a same request has been acquired in the past, when the presentation information generator 13 extracts, from the behavior list, behavior information that conforms with a predetermined evaluation criterion based on at least either the cost or the evaluation value and that satisfies the request, the presentation information generator 13 takes into consideration the percentage, associated with the same request, of users who performed the presented behavior or at which the request was fulfilled.

For example, if the percentage of users who performed a presented behavior when a same request was acquired in the past is 80%, it is permissible for the presentation information generator 13 to present behavior information to 1.25 times more users than in the case where the percentage of users in a target group who performed the presented behavior in the past or the percentage at which the request was fulfilled is not taken into consideration. Furthermore, for example, if the percentage at which the request was fulfilled when the same request was acquired in the past is 50%, it is permissible for the presentation information generator 13 to extract behavior information that fulfills a value two times greater than the requested value (a value for positive influence on the environment, for example) and to present the behavior information to the user. The likelihood of fulfilling the request therefore improves.

It should be noted that it is permissible for the transmitter/receiver 18 to receive performed-behavior information of another user in addition to the user information and behavior list of the other user. In this case, the presentation information generator 13 generates, on the basis of the performed-behavior information of the other user, performed information that displays a behavior performed by the other user, and sends the performed information to the display 14. The display 14 displays and presents the performed information to the user of interest. It is therefore possible to expect that the user of interest will be influenced by the behavior of the other user, and for the likelihood of the presented behavior being performed to further increase.

As described above, according to the behavior presentation device 1 of Embodiment 2, it is possible for the performing of a behavior that reduces an environmental burden to be prompted by presenting behavior information that reduces the environmental burden to each of the users in a target group, in accordance with the behavioral habits of the users in the target group. Therefore, it is possible to increase the likelihood of a user in the target group performing the behavior that reduces the environmental burden. Furthermore, it is possible for the behavior that reduces the environmental burden to be prompted to users in the target group in such a way that a request regarding a target-group behavior associated with the environmental burden is satisfied.

It should be noted that, in Embodiment 2, an example is given in which the target to which behavior information is presented is a group (target group) of a plurality of users. However, it is also permissible for the target to which behavior information is presented to be a single target user. In this case, it is permissible for the behavior presentation device 1 to not be provided with the transmitter/receiver 18. The request acquirer 17, for example, acquires a request regarding a target-user behavior associated with an environmental burden, such as “set 300 as the total value for positive influence on the environment of behaviors performed by the target user in one month”.

On the basis of the user information stored by the user information storer 12, the presentation information generator 13 extracts, from the behavior list stored by the behavior list storer 11, behavior information that conforms with a predetermined evaluation criterion based on at least either the cost or the evaluation value and that satisfies a request acquired by the request acquirer 17. The presentation information generator 13 generates presentation information for displaying the behavior information extracted, and sends the presentation information to the display 14.

On the basis of performed-behavior information acquired by the behavior information acquirer 15, the updater 16 determines whether or not the target user has performed a behavior indicated by the presentation information displayed on the display 14. The behavior list stored by the behavior list storer 11 and the user information stored by the user information storer 12 are then updated.

FIG. 8 is a drawing depicting an example of a hardware configuration of the behavior presentation device 1 according to the embodiments of the present invention. As depicted in FIG. 8, the behavior presentation device 1 comprises a controller 41, a main storage 42, an external storage 43, an operator 44, a display 45, and a transmitter/receiver 46. The main storage 42, external storage 43, operator 44, display 45, and transmitter/receiver 46 are all connected to the controller 41 by way of an internal bus 40.

The controller 41 comprises a CPU (central processing unit) or the like, and performs each processing in accordance with a control program 49 stored in the external storage 43. The controller 41 performs each processing for the presentation information generator 13, behavior information acquirer 15, updater 16, request acquirer 17, and transmitter/receiver 18.

The main storage 42 comprises RAM (random-access memory) or the like, has the control program 49 stored in the external storage 43 loaded thereinto, and is used as a work area for the controller 41.

The external storage 43 comprises non-volatile memory such as flash memory, a hard disk, DVD-RAM (digital versatile disc random-access memory), and DVD-RW (digital versatile disc rewritable), stores in advance a program for causing the controller 41 to perform the processing of the behavior presentation device 1, and furthermore, in accordance with an instruction of the controller 41, supplies data stored by this program to the controller 41, and stores the data supplied from the controller 41. The external storage 43 comprises the behavior list storer 11 and the user information storer 12.

The operator 44 comprises a keyboard and a pointing device such as a mouse, or the like, and an interface device that connects the keyboard and pointing device or the like to the internal bus 40. If the user inputs information to the behavior presentation device 1, instructions are supplied to the controller 41 by way of the operator 44.

The display 45 comprises a CRT (cathode ray tube) or a LCD (liquid crystal display) or the like, and displays information provided from the controller 41. The display 45 functions as the display 14.

The transmitter/receiver 46 comprises a network termination device or a wireless communication device that connects to a communication network, and a serial interface or a LAN (local area network) interface that connects thereto. The transmitter/receiver 46 functions as the behavior information acquirer 15, request acquirer 17, and transmitter/receiver 18.

Processing for the behavior list storer 11, user information storer 12, presentation information generator 13, display 14, behavior information acquirer 15, updater 16, request acquirer 17, and transmitter/receiver 18 depicted in FIG. 1 and FIG. 4 is executed by the control program 49 performing processing using the controller 41, main storage 42, external storage 43, operator 44, display 45, and transmitter/receiver 46 and the like as resources.

Otherwise, the hardware configurations and flowcharts are examples, and arbitrary alterations and modifications are possible.

It is possible for the central portion for performing the behavior presentation processing comprising the controller 41, main storage 42, external storage 43, operator 44, and internal bus 40 and the like to be implemented using an ordinary computer system without resorting to a dedicated system. For example, it is permissible to configure a behavior presentation device 1 in which the processing is executed, by a computer program for executing the aforementioned operations being stored and distributed on a computer-readable recording medium (a flexible disk, CD-ROM, DVD-ROM, or the like), and the computer program being installed on a computer. Furthermore, it is permissible to configure the behavior presentation device 1 by storing the computer program in a storage device of a computer on a communication network such as the Internet, and the computer program being downloaded and the like by an ordinary computer system.

Furthermore, if the functions of the behavior presentation device are assigned between an OS (operating system) and an application program, or are implemented by means of cooperation between an OS and an application program, and the like, it is permissible for only the application program portion to be stored on the recording medium or storage device.

Moreover, it is possible for the computer program to be superimposed on a carrier wave, and distributed by way of a communication network. For example, it is permissible for the computer program to be posted on a bulletin board system (BBS) on a communication network, and for the computer program to be distributed by way of the communication network. It is then permissible to configure the system in such a way that it is possible for the processing to be executed by running this computer program, and, under the control of the OS, executing the program in the same way as other application programs.

It is possible for the present invention to have a various types of embodiments and for these to be modified without departing from the broad spirit and scope of the present invention. Furthermore, the aforementioned embodiments are for describing the present invention, and do not restrict the scope of the present invention. In other words, the scope of the present invention is indicated by the scope of the claims rather than the embodiments. Various types of modifications implemented within the scope of the claims and within the scope of the meaning of the invention that is equivalent to the scope of the claims are deemed to be within the scope of the present invention.

It is possible for some or all of the aforementioned embodiments to be described also as in the following appendices, but are not restricted to the following.

### APPENDIX 1

A behavior presentation device comprising:

behavior list storage means that stores a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;

user information storage means that stores user information indicating a behavioral habit of the target group or the target user;

behavior information acquisition means that acquires performed-behavior information indicating a behavior performed by the target group or the target user;

update means that updates the behavior list and the user information on the basis of the performed-behavior information;

extraction means that, on the basis of the user information, extracts behavior information for which at least either the cost or the evaluation value conforms with a predetermined evaluation criterion, from among the behavior information included in the behavior list;

generation means that generates presentation information for displaying the behavior information extracted; and

presentation means that presents the presentation information to the target group or the target user.

### APPENDIX 2

The behavior presentation device according to Appendix 1, wherein

the update means, on the basis of the performed-behavior information of the target group or the target user, determines whether or not a behavior indicated by the presentation information presented by the presentation means has been performed by the target group or the target user, and applies a weighting to a cost corresponding to a behavior that has been performed by the target group or the target user or a behavior that has not been performed, from among the behavior information included in the behavior list.

### APPENDIX 3

The behavior presentation device according to Appendix 1 or 2, wherein

the generation means, on the basis of, from among the performed-behavior information acquired by the behavior information acquisition means, the performed-behavior information of another user besides a user of interest included in the target group, generates performed information for displaying a behavior performed by the other user, and

the presentation means presents the performed information to the user of interest.

### APPENDIX 4

The behavior presentation device according to any one of Appendices 1 to 3, further comprising:

request acquisition means that acquires a request regarding an environmental burden-associated behavior of the target group or the target user

wherein, on the basis of the user information, the extraction means extracts, from the behavior list, the behavior information that conforms with the predetermined evaluation criterion and satisfies the request.

### APPENDIX 5

The behavior presentation device according to Appendix 4, wherein

the update means, on the basis of the performed-behavior information of the target group, separates the users included in the target group into groups for each type of behavior, and

the extraction means extracts, from the behavior list, the behavior information that is behavior information of a user belonging to a group corresponding to the type of the behavior indicated in the request, and that conforms with the predetermined evaluation criterion and satisfies the request.

### APPENDIX 6

The behavior presentation device according to Appendix 4 or 5, further comprising:

percentage storage means that, on the basis of the performed-behavior information, computes a percentage of users who have performed the behavior presented by the presentation means or a percentage at which the request has been fulfilled, and associates and stores the request and the percentage

wherein the extraction means determines whether or not a request comprising the same content as the request acquired by the request acquisition means has been acquired in the past, and, if a request comprising the same content as the request has been acquired in the past, extracts behavior information that conforms with the predetermined evaluation criterion and satisfies the request, from the behavior list, in accordance with the percentage associated with the request comprising the same content as the request.

### APPENDIX 7

A behavior presentation method performed by a behavior presentation device that presents a behavior to a target user, the behavior presentation method comprising:

a behavior list storage step for storing a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;

a user information storage step for storing user information indicating a behavioral habit of the target group or the target user;

a behavior information acquisition step for acquiring performed-behavior information indicating a behavior performed by the target group or the target user;

an update step for updating the behavior list and the user information on the basis of the performed-behavior information;

an extraction step for, on the basis of the user information, extracting behavior information for which at least either the cost or the evaluation value conforms with a predetermined evaluation criterion, from among the behavior information included in the behavior list;

a generation step for generating presentation information for displaying the behavior information extracted; and

a presentation step for presenting the presentation information to the target group or the target user.

### APPENDIX 8

The behavior presentation method according to Appendix 7, wherein,

in the update step, whether or not a behavior indicated by the presentation information presented in the presentation step has been performed by the target group or the target user is determined on the basis of the performed-behavior information of the target group or the target user, and a weighting is applied to a cost corresponding to a behavior that has been performed by the target group or the target user or a behavior that has not been performed, from among the behavior information included in the behavior list.

### APPENDIX 9

The behavior presentation method according to Appendix 7 or 8, wherein,

in the generation step, on the basis of, from among the performed-behavior information acquired in the behavior information acquisition step, the performed-behavior information of another user besides a user of interest included in the target group, performed information for displaying a behavior performed by the other user is generated, and in the presentation step, the performed information is presented to the user of interest.

### APPENDIX 10

The behavior presentation method according to any one of Appendices 7 to 9, further comprising:

a request acquisition step for acquiring a request regarding an environmental burden-associated behavior of the target group or the target user

wherein, in the extraction step, the behavior information that conforms with the predetermined evaluation criterion and satisfies the request is extracted from the behavior list on the basis of the user information.

### APPENDIX 11

The behavior presentation method according to Appendix 10, wherein,

in the update step, the users included in the target group are separated into groups for each type of behavior on the basis of the performed-behavior information of the target group, and

in the extraction step, the behavior information that is behavior information of a user belonging to a group corresponding to the type of the behavior indicated in the request, and that conforms with the predetermined evaluation criterion and satisfies the request is extracted from the behavior list.

### APPENDIX 12

The behavior presentation method according to Appendix 10 or 11, further comprising:

a percentage storage step for, on the basis of the performed-behavior information, computing a percentage of users who have performed the behavior presented in the presentation step or a percentage at which the request has been fulfilled, and associating and storing the request and the percentage

wherein, in the extraction step, whether or not a request comprising the same content as the request acquired in the request acquisition step has been acquired in the past is determined, and, if a request comprising the same content as the request has been acquired in the past, behavior information that conforms with the predetermined evaluation criterion and satisfies the request is extracted from the behavior list in accordance with the percentage associated with the request comprising the same content as the request.

### APPENDIX 13

A computer-readable recording medium storing a program causing a computer to function as:

behavior list storage means that stores a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;

user information storage means that stores user information indicating a behavioral habit of the target group or the target user;

behavior information acquisition means that acquires performed-behavior information indicating a behavior performed by the target group or the target user;

update means that updates the behavior list and the user information on the basis of the performed-behavior information;

extraction means that, on the basis of the user information, extracts behavior information for which at least either the cost, or the evaluation value conforms with a predetermined evaluation criterion, from among the behavior information included in the behavior list;

generation means that generates presentation information for displaying the behavior information extracted; and

presentation means that presents the presentation information to the target group or the target user.

The present invention is based upon Japanese Patent Application No. 2011-108498 filed on May 13, 2011. The entirety of the specification, scope of the patent claims, and drawings of Japanese Patent Application No. 2011-108498 is incorporated by reference herein.

### INDUSTRIAL APPLICABILITY

It is possible for the present invention to be applied to a behavior presentation device that prompts a user with a behavior that reduces an environmental burden.

### REFERENCE SIGNS LIST

1 Behavior presentation device
11 Behavior list storer
12 User information storer
13 Presentation information generator
14 Display
15 Behavior information acquirer
16 Updater
17 Request acquirer
18 Transmitter/receiver
40 Internal bus
41 Controller
42 Main storage
43 External storage
44 Operator
43 Display
46 Transmitter/receiver
49 Control program

What is claimed is:

1. A behavior presentation device comprising:
behavior list storage means that stores a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;
user information storage means that stores user information indicating a behavioral habit of the target group or the target user;
behavior information acquisition means that acquires performed-behavior information indicating a behavior performed by the target group or the target user;
update means that updates the behavior list and the user information on the basis of the performed-behavior information;
extraction means that, on the basis of the user information, extracts behavior information for which at least either the cost or the evaluation value conforms with a predetermined evaluation criterion, from among the behavior information included in the behavior list;
generation means that generates presentation information for displaying the behavior information extracted; and
presentation means that presents the presentation information to the target group or the target user.

2. The behavior presentation device according to claim 1, wherein
the update means, on the basis of the performed-behavior information of the target group or the target user, determines whether or not a behavior indicated by the presentation information presented by the presentation means has been performed by the target group or the target user, and applies a weighting to a cost corresponding to a behavior that has been performed by the target group or the target user or a behavior that has not been performed, from among the behavior information included in the behavior list.

3. The behavior presentation device according to claim 1, wherein
the generation means, on the basis of, from among the performed-behavior information acquired by the behavior information acquisition means, the performed-behavior information of another user besides a user of interest included in the target group, generates performed information for displaying a behavior performed by the other user, and
the presentation means presents the performed information to the user of interest.

4. The behavior presentation device according to claim 1, further comprising:
request acquisition means that acquires a request regarding an environmental burden-associated behavior of the target group or the target user
wherein, on the basis of the user information, the extraction means extracts, from the behavior list, the behavior information that conforms with the predetermined evaluation criterion and satisfies the request.

5. The behavior presentation device according to claim 4, wherein
the update means, on the basis of the performed-behavior information of the target group, separates the users included in the target group into groups for each type of behavior, and
the extraction means extracts, from the behavior list, the behavior information that is behavior information of a user belonging to a group corresponding to the type of the behavior indicated in the request, and that conforms with the predetermined evaluation criterion and satisfies the request.

6. The behavior presentation device according to claim 4, further comprising:
percentage storage means that, on the basis of the performed-behavior information, computes a percentage of users who have performed the behavior presented by the presentation means or a percentage at which the request has been fulfilled, and associates and stores the request and the percentage
wherein the extraction means determines whether or not a request comprising the same content as the request acquired by the request acquisition means has been acquired in the past, and, if a request comprising the same content as the request has been acquired in the past, extracts behavior information that conforms with the predetermined evaluation criterion and satisfies the request, from the behavior list, in accordance with the percentage associated with the request comprising the same content as the request.

7. A behavior presentation method performed by a behavior presentation device that presents a behavior to a target user, the behavior presentation method comprising:
a behavior list storage step for storing a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;
a user information storage step for storing user information indicating a behavioral habit of the target group or the target user;
a behavior information acquisition step for acquiring performed-behavior information indicating a behavior performed by the target group or the target user;
an update step for updating the behavior list and the user information on the basis of the performed-behavior information;
an extraction step for, on the basis of the user information, extracting behavior information for which at least either the cost or the evaluation value conforms with a predetermined evaluation criterion, from among the behavior information included in the behavior list;
a generation step for generating presentation information for displaying the behavior information extracted; and
a presentation step for presenting the presentation information to the target group or the target user.

8. The behavior presentation method according to claim 7, wherein,
in the update step, whether or not a behavior indicated by the presentation information presented in the presentation step has been performed by the target group or the target user is determined on the basis of the performed-behavior information of the target group or the target user, and a weighting is applied to a cost corresponding to a behavior that has been performed by the target group or the target user or a behavior that has not been performed, from among the behavior information included in the behavior list.

9. The behavior presentation method according to claim 7, wherein,
in the generation step, on the basis of, from among the performed-behavior information acquired in the behavior information acquisition step, the performed-behavior information of another user besides a user of interest included in the target group, performed information for displaying a behavior performed by the other user is generated, and
in the presentation step, the performed information is presented to the user of interest.

10. A computer-readable recording medium storing a program causing a computer to function as:
behavior list storage means that stores a behavior list in which behavior information indicating a possible behavior of a target group comprising a plurality of users or a single target user and at least either a cost indicating the difficulty of the behavior, or an evaluation value indicating an effect or a benefit produced if the behavior is performed are associated;
user information storage means that stores user information indicating a behavioral habit of the target group or the target user;
behavior information acquisition means that acquires performed-behavior information indicating a behavior performed by the target group or the target user;
update means that updates the behavior list and the user information on the basis of the performed-behavior information;
extraction means that, on the basis of the user information, extracts behavior information for which at least either the cost or the evaluation value conforms with a predetermined evaluation criterion, from among the behavior information included in the behavior list;
generation means that generates presentation information for displaying the behavior information extracted; and
presentation means that presents the presentation information to the target group or the target user.
